(19) United States
(12) Patent Application Publication
(10) Pub. No.: US 2015/0097309 A1
(43) Pub. Date: Apr. 9, 2015

(54) PROCESS AND APPARATUS FOR MAKING TUFTED ARTICLE

(71) Applicant: The Procter & Gamble Company, Cincinnati, OH (US)

(72) Inventors: Matthew Lloyd NEWMAN, Mason, OH (US); Gene Michael ALTONEN, West Chester, OH (US); Casey Joseph GUSTAFSON, Iowa City, IA (US)

(73) Assignee: The Procter & Gamble Company, Cincinnati, OH (US)

(21) Appl. No.: 14/046,338

(22) Filed: Oct. 4, 2013

(51) Int. Cl. B29C 45/14

(52) U.S. Cl. CPC B29C 45/14
USPC 264/40.7; 425/123

(57) ABSTRACT

A process for making a tufted article from a thermoplastic material comprises controlling injection pressure according to a pressure-dominated algorithm including detecting at least 100 melt-pressure measurements per second upstream a front end of a mold cavity. An apparatus comprises a pressure-control mechanism for monitoring and adjusting an injection pressure according to the pressure-dominated algorithm, wherein the pressure-control mechanism comprises at least one high-frequency pressure sensor located upstream the mold cavity's front end.

### TECHNICAL FIELD

The present invention relates to injection-molding machines and methods for producing tufted articles by injection molding, and more particularly to injection-molding processes and apparatuses wherein low-pressure injection molding is controlled by a pressure-dominated algorithm.

### BACKGROUND

Injection molding is a technology commonly used for high-volume manufacturing of parts made of meltable material, most commonly of parts made of thermoplastic polymers. A typical injection-molding procedure comprises basic operations of heating a plastic material in an injection-molding machine to allow the plastic to flow under pressure, injecting the melted plastic into a mold cavity or cavities defined between two mold parts that have been closed, allowing the plastic under pressure to cool and harden in the cavity or cavities, opening the mold cavity or cavities, and ejecting the molded article from the mold. Each mold cavity may be connected to a flow channel by a gate, which directs the flow of the molten resin into the cavity. There can be one or more gates.

During the injection-molding process, the molten plastic resin is injected into the mold cavity by the injection-molding machine until the plastic resin reaches the location in the cavity furthest from the gate. Thereafter, the plastic resin fills the cavity from the end back towards the gate. Once a liquid plastic resin is introduced into an injection mold in a conventional high-variable-pressure injection-molding machine, the material adjacent to the walls of the cavity immediately begins to “freeze,” or solidify, or cure. In the case of crystalline polymers, the plastic resin begins to crystallize, because the liquid plastic resin cools to a temperature below the material's no-flow temperature, and portions of the liquid plastic solidify and become stationary. This frozen material adjacent to the walls of the mold narrows the flow path that the thermoplastic travels as it progresses to the end of the mold cavity. The thickness of the frozen material layer adjacent to the walls of the mold increases as the filling of the mold cavity progresses, which causes a progressive reduction in the cross-sectional area through which the polymer must flow to continue to fill the mold cavity. As material freezes, it also shrinks, pulling away from the mold cavity walls, which reduces effective cooling of the material by the mold cavity walls. Therefore, conventional high-variable-pressure injection-molding machines are designed to fill the mold cavity with plastic very quickly and to maintain a packing pressure to force the material outward against the sides of the mold cavity—to enhance cooling and to maintain the correct shape of the molded part. Conventional high-variable-pressure injection-molding machines typically have cycle times made up of about 10% injection time, about 50% packing time, and about 40% cooling time.

As plastic freezes in the mold cavity, conventional high-variable-pressure injection-molding machines increase injection pressure (to maintain a substantially constant volumetric flow rate due to the smaller cross-sectional flow area). Increasing the pressure, however, has both cost and performance downsides. As the pressure required to mold the component increases, the molding equipment must be strong enough to withstand the additional pressure, which generally causes the equipment to be more expensive. A manufacturer may have to purchase new equipment to accommodate these increased pressures, which naturally results in significant capital expenses.

In an effort to avoid some of the drawbacks mentioned above, many conventional injection-molding operators use shear-thinning plastic material to improve flow characteristics of the plastic material in the mold cavity. As the shear-thinning plastic material is injected into the mold cavity, shear forces generated between the plastic material and the mold cavity walls tend to reduce viscosity of the plastic material, thereby allowing the plastic material to flow more freely and easily into the mold cavity. As a result, it is possible to fill the mold cavity fast enough to avoid the freeze off of the material before the mold is completely filled.

Reduction in viscosity is directly related to the magnitude of shear forces generated between the plastic material and the feed system, and between the plastic material and the mold cavity wall. Thus, manufacturers of these shear-thinning materials and operators of injection-molding systems have been driving injection-molding pressures higher in an effort to increase shear, thus reducing viscosity. Typically, high output injection-molding systems (e.g., class 101 and class 30 systems) inject the plastic material in to the mold cavity at melt pressures of typically 15,000 psi or more. Manufacturers of shear-thinning plastic material teach injection-molding operators to inject the plastic material into the mold cavities above a minimum melt pressure. For example, polypropylene resin is typically processed at pressures greater than 6,000 psi, the recommended range from the polypropylene resin manufacturers being typically from greater than 6,000 psi to about 15,000 psi. Press manufacturers and processing engineers typically recommend processing shear-thinning polymers at the top end of the range, or significantly higher, to achieve maximum potential shear thinning, which is typically greater than 15,000 psi, to extract maximum thinning and better flow properties from the plastic material. Shear thinning thermoplastic polymers generally are processed in the range of over 6,000 psi to about 30,000 psi.

High-production injection-molding machines (i.e., class 101 and class 30 molding machines) typically experience 500,000 cycles per year or more. Industrial-quality-production molds must be designed to withstand at least 500,000 cycles per year, preferably more than 1,000,000 cycles per year, more preferably more than 5,000,000 cycles per year, and even more preferably more than 10,000,000 cycles per year. These machines have multi-cavity molds and complex cooling systems to increase production rates. The high-hardness materials are more capable of withstanding the repeated high-pressure clamping operations than lower-hardness materials. But high-hardness materials, such as most tool steels, have relatively low thermal conductivities, generally less than 20 BTU/HR FT ° F., which leads to long cooling times as heat is transferred from the molten plastic material through the high hardness material.

In the conventional machines, control systems for controlling and adjusting the injection parameters are typically based on a sequential rate-dominated algorithm followed by a pressure-dominated algorithm. The conventional machine typically injects first 90-98% of the volume of a plastic shot at the highest possible injection rate—to take advantage of the shear-thinning nature of most thermoplastic materials. The occurrence of plastic seepage between mold faces at the parting lines, commonly known as “flash,” typically occurs at or near the end of the injection cycle due to a pressure spike caused by the final filling of the cavity, or during packing at high pressure in the pressure-dominated stage of the control algorithm. An injection-molding control system can be used to accurately reduce cavity pressure at or near the end of the injection cycle. To prevent spikes in pressure, which are likely to occur at the end of the injection, the machine can switch to a pressure-controlled algorithm for the final portion of the injection cycle. U.S. Pat. No. 6,060,005, for example, teaches a control algorithm that includes sequential application of a rate-dominated control followed by a pressure-dominated control, to maintain the molten-flow front substantially unbroken during the molding process. Since it is desirable to inject the plastic material as quickly as possible and to reach the threshold injection pressure as quickly as possible, it appears logical to provide for the rate-controlled initial injection phase. It appears desirable, in some cases, to limit injection pressure early in the molding cycle to prevent excess wear on gates or other high-shear areas caused by extremely high injection speeds; but in those cases, pressure is typically limited to 30,000 psi or less, or 20,000 psi or less, or some level that is below the fatigue limit of the material comprising the injection gate. In those cases, the pressure threshold can be set to protect mold components from wear or premature failure, and the quality of the final molded part is not a factor in the determination of this pressure threshold. The control algorithm comprising sequential application of the rate-dominated protocol and the pressure-dominated protocol will thus suffice for many applications where the quality of the part being made is relatively insensitive to the history of the cavity pressure near the beginning of the injection cycle.

We have now discovered that the rate-dominated control algorithm can be beneficially eliminated altogether in favor of using only a pressure-dominated control algorithm, particularly for the applications in which the physical characteristics and appearance of the final product can be appreciably influenced by the pressures occurring near the beginning of the injection cycle. We have further discovered that the exclusive use of the pressure-dominated control algorithm in the injection-molding process for constructing parts sensitive to injection-pressure fluctuations can provide superior quality of the finished product. We have also discovered that it is beneficial in some applications to have the first plastic shot injected at a low constant pressure.

### SUMMARY OF THE INVENTION

A process for making a tufted article comprises: causing at least a first mold part and a second mold part to form a first mold cavity therebetween, the first mold part having a working surface and a plurality of holes formed therein to receive a plurality of bristle tufts, each bristle tuft comprising a plurality of individual bristles, the first mold cavity having a volume, a front end, and a rear end opposite to the front end; inserting the plurality of bristle tufts into the plurality of holes in the first mold part, each of the bristle tufts having a first end, a second end opposite to the first end, and a longitudinal axis running though the first and second ends, the first ends of the bristle tufts being disposed inside the first mold part while the second ends of the bristle tufts extend into the first mold cavity; injecting a molten first thermoplastic material into the first mold cavity through a front end thereof, thereby interconnecting the second ends of the plurality of bristle tufts with the first thermoplastic material, the molten first thermoplastic material having a melt-flow index of from about 0.1 g/10 min to about 500 g/10 min and a melt pressure in the first mold cavity of from about 10 psi to about 2000 psi; controlling and adjusting melt pressure of the molten first thermoplastic material according to a pressure-dominated algorithm comprising detecting at least 100 melt-pressure measurements per second upstream the front end of the first mold cavity; cooling the molten first thermoplastic material thereby causing the first thermoplastic material to solidify inside the first mold cavity; and disengaging the first mold part and the second mold part thereby releasing the solidified first thermoplastic material having the plurality of bristle tufts embedded therein.

An apparatus for making a tufted body by injection-molding comprises: at least a first mold part and a second mold part, the first and second mold parts forming herebetween a first mold cavity for receiving a molten first thermoplastic material therein, the first mold cavity having a volume, a front end, and a rear end opposite to the front end, the first mold part having a working surface and a plurality of holes formed therein for receiving a plurality of bristle tufts, each bristle tuft comprising a plurality of individual bristles; an injection device comprising at least a first injection nozzle for injecting a molten first thermoplastic material into the first mold cavity; and a pressure-control mechanism for monitoring a melt pressure of the molten first thermoplastic material and adjusting an injection pressure imparted by the injection device on the molten first thermoplastic material according to a pressure-dominated algorithm based on the melt pressure of the molten first thermoplastic material inside the first mold cavity.

### BRIEF DESCRIPTION OF THE DRAWINGS

The embodiments set forth in the drawings are illustrative and exemplary in nature—and are not intended to limit the subject matter defined by the claims. The detailed description of the illustrative embodiments can be understood when read in conjunction with the drawings, where like structures are indicated with like reference numerals and in which:

FIGS. 1 and 2 schematically illustrate an embodiment of a low-constant-pressure injection-molding machine according to the disclosure;

FIG. 3 is a graph showing cavity pressure vs. time for the low-constant-pressure injection-molding machine of FIG. 1, superimposed over a graph showing cavity pressure vs. time for a conventional high-variable-pressure injection-molding machine;

FIG. 4 is another graph showing cavity pressure vs. time for the low-constant-pressure injection-molding machine of FIG. 1 superimposed over a graph showing cavity pressure vs. time for a conventional high-variable-pressure injection-molding machine, the graphs illustrating the percentage of fill time devoted to several fill steps;

FIGS. 5A-5H are schematic illustrations of several steps of the injection-molding process for making a tufted article according to the disclosure.

FIG. 6 is a schematic cross-sectional and fragmental view showing one tuft having a fuse ball at one of its ends.

### DETAILED DESCRIPTION

As used herein, the following terms have the following meanings.

The term “low pressure” of a thermoplastic material means melt pressures of 6000 psi and lower, as measured at an injection nozzle of an injection-molding apparatus. A reference to pressure “measured at a nozzle” (and the like) refer to measurements of the molten material's pressure taken upstream the exit orifice of the injection nozzle, either inside the injection nozzle or in an area immediately upstream the injection nozzle.

The term “gate size” generally refers to the cross-sectional area of a gate, which is formed by the intersection of the runner and the mold cavity. For hot-runner systems, the gate can be of an open design, where there is no positive shut off of the flow of material at the gate—or a closed design, where a valve pin is used to mechanically shut off the flow of material through the gate in to the mold cavity. (The latter type of gate is also conventionally known as a “valve gate.”) For example, a gate having a 1-mm gate diameter refers to a gate having a cross-sectional area that is equivalent to the cross-sectional area of a gate having a 1-mm diameter at the point the gate meets the mold cavity. The cross-section of the gate may be of any desired shape.

The term “hesitation” generally refers to the point at which the velocity of the flow front is minimized sufficiently to allow a portion of the polymer to drop below its no-flow temperature and begin to freeze off.

The term “low-constant-pressure injection-molding machine” is a class-101 or a class-30 injection-molding machine that uses a substantially constant injection pressure that is less than 6000 psi. Low-constant-pressure injection-molding machines may be high-productivity injection-molding machines (e.g., a class 101 or a class 30 injection-molding machine, or an “ultra-high-productivity molding machine”), such as, e.g., the high-productivity injection-molding machine disclosed in U.S. patent application Ser. No. 13/601,514, the disclosure of which is incorporated by reference herein.

The terms “substantially,” “about,” “approximately,” and the like, may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue. Further, the dimensions and values disclosed herein are not to be understood as being strictly limited to the exact numerical values recited. Instead, unless otherwise specified, each such dimension is intended to mean both the recited value and a functionally equivalent range surrounding that value. For example, a value disclosed as “50%” is intended to mean “about 50%.” Thus, e.g., the term “substantially constant pressure” of a thermoplastic material means that deviations from a baseline melt pressure do not produce meaningful changes in physical properties (such as, e.g., viscosity) of the thermoplastic material.

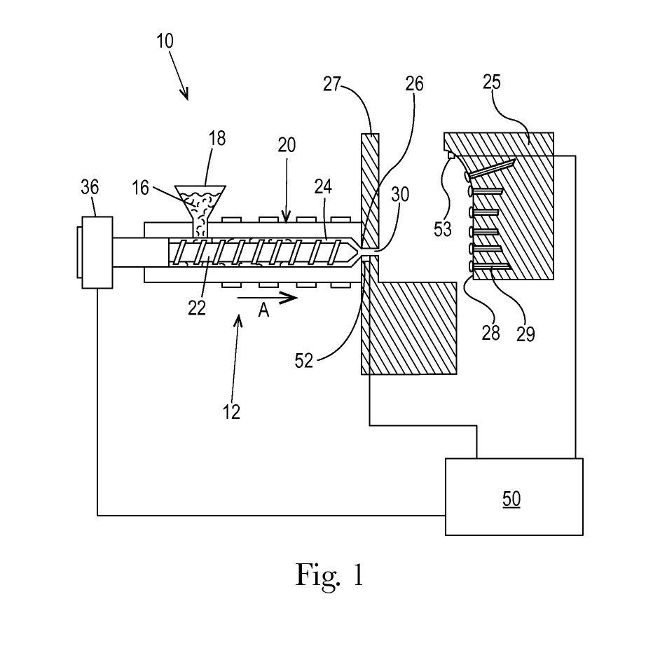

FIG. 1 illustrates an embodiment of a low-constant-pressure injection-molding apparatus 10 of the invention. The apparatus 10 includes an injection system 12. A first thermoplastic material (e.g., in the form of thermoplastic pellets 16) may be introduced to the injection system 12 through a hopper 18 that feeds the first thermoplastic material 16 into a heated barrel 20. The pellets 16, after being fed into the heated barrel 20, may be driven to the end of the heated barrel 20 by a reciprocating screw 22, controlled by a screw-control mechanism 36. The heating of the heated barrel 20 and the compression of the pellets 16 by the screw 22 causes the pellets 16 to melt, forming a molten thermoplastic material 24. The molten first thermoplastic material 24 is typically processed at a temperature of about 130° C. to about 410° C.

The screw 22 forces the molten thermoplastic material 24, toward a first nozzle 26 (arrow A in FIG. 1) to form a shot of thermoplastic material, which will be injected into a first mold cavity 32 of a mold 28 via one or more gates 30. The screw 22 can be controlled by a screw-control mechanism 36. In some embodiments, the first nozzle 26 may be separated from one or more gates 30 by a feed system (not shown). The mold cavity 32 is formed between a first mold part 25 and a second mold part 27. The first and second mold parts 25, 27 can be held together under pressure by any means known in the art, for example, press, or clamping unit. During the molding process, the clamping unit applies a clamping force that is greater than the force exerted by the injection pressure acting to separate the two mold parts 25, 27. This holds the first and second mold sides 25, 27 together while the molten thermoplastic material 24 is injected into the mold cavity 32. The first nozzle 26 is in fluid communication with the first mold cavity 32 through a first gate 30.

Once the shot of molten first thermoplastic material 24 is injected into the mold cavity 32, the reciprocating screw 22 stops traveling forward. The molten first thermoplastic material 24 takes the form of the mold cavity 32 and cools inside the mold 28 until it solidifies. Once the first thermoplastic material 24 has solidified, the first and second mold parts 25, 27 can be disengaged, thereby releasing the solidified first thermoplastic material comprising a finished part. The mold 28 may include a plurality of mold cavities 32 to increase overall production rates. The shapes of the plurality of mold cavities may be identical or similar to one another—or different from one another. (The latter may be referred to as a “family of mold cavities”).

The injection-molding process of the invention is controlled solely by a pressure-dominated algorithm. This includes high-frequency monitoring of at least a first melt pressure of the molten first thermoplastic material 24 upstream the first mold cavity 32. This high-frequency monitoring can be done at the first injection nozzle 26, disposed adjacent to the front 32a end of the first mold cavity 32 (and being in fluid communication therewith through the first gate 30). A first high-frequency pressure sensor 52 is located upstream the front end 32a of the mold cavity 32 and downstream the injection system 12, including the screw 22. The sensor 52 can be disposed, for example, either inside the first injection nozzle 26 or immediately upstream the first injection nozzle 26, to detect the resulting pressure of the molten first material 24 exiting the injection system 12 and entering the first mold cavity 32. A second high-frequency pressure sensor 53 can be located at the rear end 32b of the first mold cavity 32, near an end of flow position, to monitor a second melt pressure of the molten first thermoplastic material 24, when the front of the molten first material 24 reaches the end of the first mold cavity 32. The second sensor 53 detects the pressure when from about 90% to about 99% of a total volumetric capacity of the first mold cavity 32 is filled with the molten first thermoplastic material 24.

The first sensor 52 and/or the second sensor 53 can be communicatively connected with a controller 50. The controller 50 may comprise a central processing unit (CPU), including a microprocessor, a memory, and one or more communication links, including at least one input and at least one output. The controller 50 can be configured to receive and analyze the high-frequency injection-pressure readings from at least one of the sensors 52, 53. The analysis of the pressure reading may include averaging of the pressure measurements and computing an optimal pressure for a given stage of the injection-molding process. The controller 50 can be configured to communicate with the injection system 12 to control the injection pressure in accordance with the desired algorithm. This may include maintaining, changing, and adjusting the injection pressure with high frequency, based on the high-frequency readings received from at least one of the sensors 52, 53. The controller 50 can be also configured to transfer control of the injection pressure to or from another injection-molding control system. Other sensors (not shown), such, for example, as optical, pneumatic, temperature, and mechanical, operatively connected to the controller 50, can be utilized as well. These sensors can provide an indication of when the molten thermoplastic material 24 is approaching the end of fill in the mold cavity 32.

Measurements from at least one of the sensors 52, 53 are communicated to the controller 50 to allow the controller 50 to correct the process in real time—to ensure that the melt-front pressure is relieved prior to the melt front reaching the very end of the mold cavity, to avoid flashing of the mold and another pressure-and-power peak. Moreover, the controller 50 may use the pressure measurements to adjust the peak power and peak flow rate points in the process, to achieve consistent processing conditions. In addition to using the pressure measurements to fine-tune the process in real time during the current injection cycle, the controller may also adjust the process over time (e.g., over a plurality of injection cycles). In this way, the current injection cycle can be corrected based on measurements occurring during one or more cycles at an earlier point in time. In some embodiments, pressure readings can be averaged over many cycles so as to achieve process consistency.

Any type of high-frequency sensor 52, 53 that can detect at least 100, at least 200, at least 300, at least 400, or at least 500 pressure measurements per second can be used. Examples include piezoelectric transducers, sonic transducers, ultrasonic transducers, sub-surface transducers, flush-mount transducers, mechanical transducers, machinable transducers, coulombic charge-generating transducers, and other devices suitable for such a purpose. One example a suitable transducer can be found in Patent Application US20100242616A1, the disclosure of which is incorporated herein by reference.

The first and/or second high-frequency sensor 52, 53 can be installed by any means known in the art. For example, the sensor 52 can be installed at the first nozzle 26 by forming a hole therein to establish fluid communication between the molten-plastic side of the nozzle cavity and atmosphere and embedding the transducer into the hole, and then resealing the hole to prevent leakage of the molten material to the outside surface of the injection nozzle. In another embodiment, the hole may be drilled blind from the atmosphere side, for example, to improve sealing of plastic side of the nozzle. In any embodiment, the sensor may be held in place via screw threads on the outer surface of the sensor designed for this purpose. Alternatively, the sensor may be fixed inside the hole by friction due to physical contact between the outer surface of the sensor housing and the surface of the hole.

When pressure of the thermoplastic material 24 is measured by at least one of the high-frequency sensors 52, 53 the sensor sends a signal indicative of the pressure to the controller 50 to provide a target pressure to be maintained in the mold cavity 32 or in the nozzle 26 as the fill is completed. This signal may generally be used to control the molding process, such that variations in material viscosity, mold temperatures, melt temperatures, and other varying factors influencing filling rate, are adjusted by the controller 50. These adjustments may be made immediately during the molding cycle, or corrections can be made in subsequent cycles. Furthermore, several signals may be averaged over a number of cycles and then used to make adjustments to the molding process by the controller 50. The controller 50 may be connected to the sensors 52, 53, and the screw-control mechanism 36 via electrical wired connections 54, 56, respectively (FIG. 1). In other embodiments, the controller 50 may communicate with any of the sensors 52, 53, and the screw control 56 via a wireless connection, a mechanical connection, a hydraulic connection, a pneumatic connection, or any other type of communication connection.

Although an active, closed-loop controller 50 is illustrated in the embodiment of FIG. 1, other pressure-regulating devices may be used instead, such, e.g., as a pressure-regulating valve or a pressure-relief valve (neither shown). These valves can prevent over-pressurization of the mold 28. Another mechanism for preventing over-pressurization of the mold 28 can include an alarm activated when an over-pressurization condition is detected.

It was generally believed that filling at a substantially constant pressure would allow one to reduce the filling rates relative to those of conventional filling methods. Reduced filling rates would cause the polymer to be in contact with the cool molding surfaces for longer periods before the mold is completely filled. Thus, more heat would need to be removed before filling. This would be expected to result in the material freezing off, thereby plugging the mold cavity, before the mold is filled.

We have discovered that the thermoplastic material will flow even when subjected to substantially constant low pressure even when a portion of the mold cavity may be below the no-flow temperature of the thermoplastic material. Without intending to be bound by theory, we believe that the substantially constant low injection pressure would cause beneficial dynamic flow conditions (i.e., constantly moving melt front) through the entire mold cavity during filling. There is no hesitation in the flow of the molten thermoplastic material as it flows to fill the mold cavity—and thus no opportunity for freeze-off of the flow, despite the fact that at least a portion of the mold cavity is below the thermoplastic material's no-flow temperature. As a result of the dynamic flow conditions, including shear heating, the molten thermoplastic material would be able to maintain a temperature higher than the no-flow temperature, despite being subjected to no-flow temperatures in the mold cavity. The dynamic flow conditions interfere with the formation of crystal structures in the thermoplastic material as it begins the freezing process. The formation of crystal structures increases the viscosity of the thermoplastic material, which can prevent suitable flow to fill the cavity. The interference with, and reduction of, the crystal-structure formation, including size reduction of the crystal-structure elements, would cause a decrease in the thermoplastic material's viscosity as the material flows into the cavity—even though it is subjected to the temperature below the no-flow temperature.

The injection-molding apparatus 10 can include a cooling system (not shown) that maintains the entire mold cavity 32 at a temperature below the no-flow temperature. The mold cavity's interior surfaces, which contact the molten thermoplastic material 24, can be cooled to maintain a lower temperature. Any suitable cooling temperature can be used. For example, the mold 28 can be maintained substantially at room temperature. Incorporation of such cooling systems can advantageously enhance the rate at which the injection-molded part is cooled and ready for ejection from the mold 28.

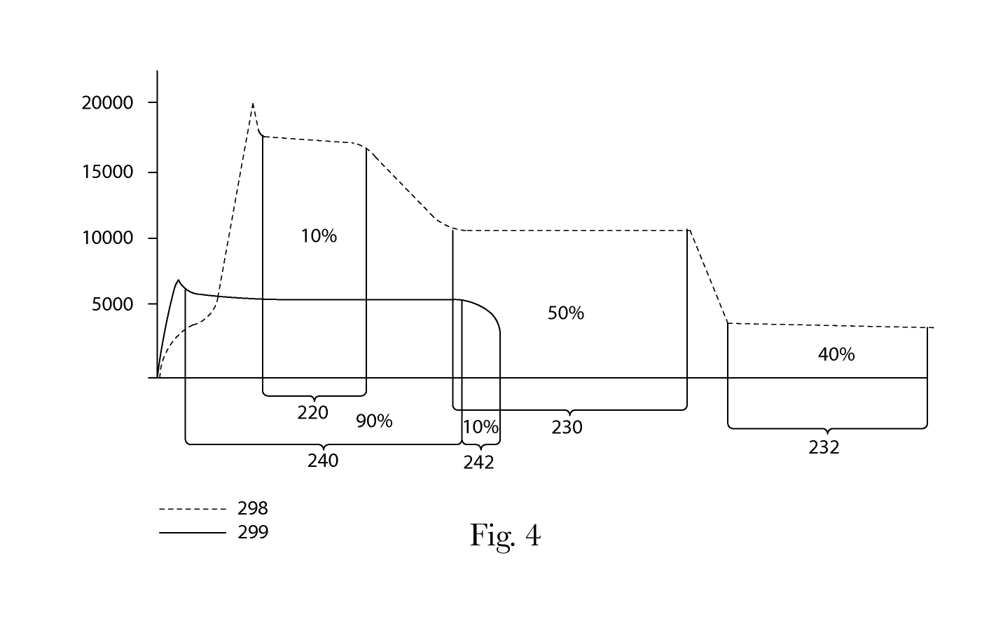

FIGS. 5A-5H schematically illustrate several steps of a process for making a tufted article according to the disclosure. The first mold part 25 has a working surface 28 and a plurality of holes 29 formed therein to receive a plurality of bristle tufts 40, each bristle tuft comprising a plurality of individual bristles. The plurality of bristle tufts 40, each having a first end 43 and a second end 45 opposite to the first end 43, can be inserted into the plurality of holes 29 in the first mold part 25 so that the first ends 43 of the bristle tufts 40 are disposed inside the first mold part 25 while the second ends 45 extend into the first mold cavity 32. The pattern of the holes 29, including their depths, profiles, and angles at which they extend into the first mold part 25, is determined by the desired configuration of the plurality of tufts 40 on the finished tufted article. In FIGS. 1 and 2, for example, the holes 29 have differential depths and differential angles. This will cause the tufts 40 on the finished article to have an overall profile corresponding to the one shown in FIGS. 1 and 2.

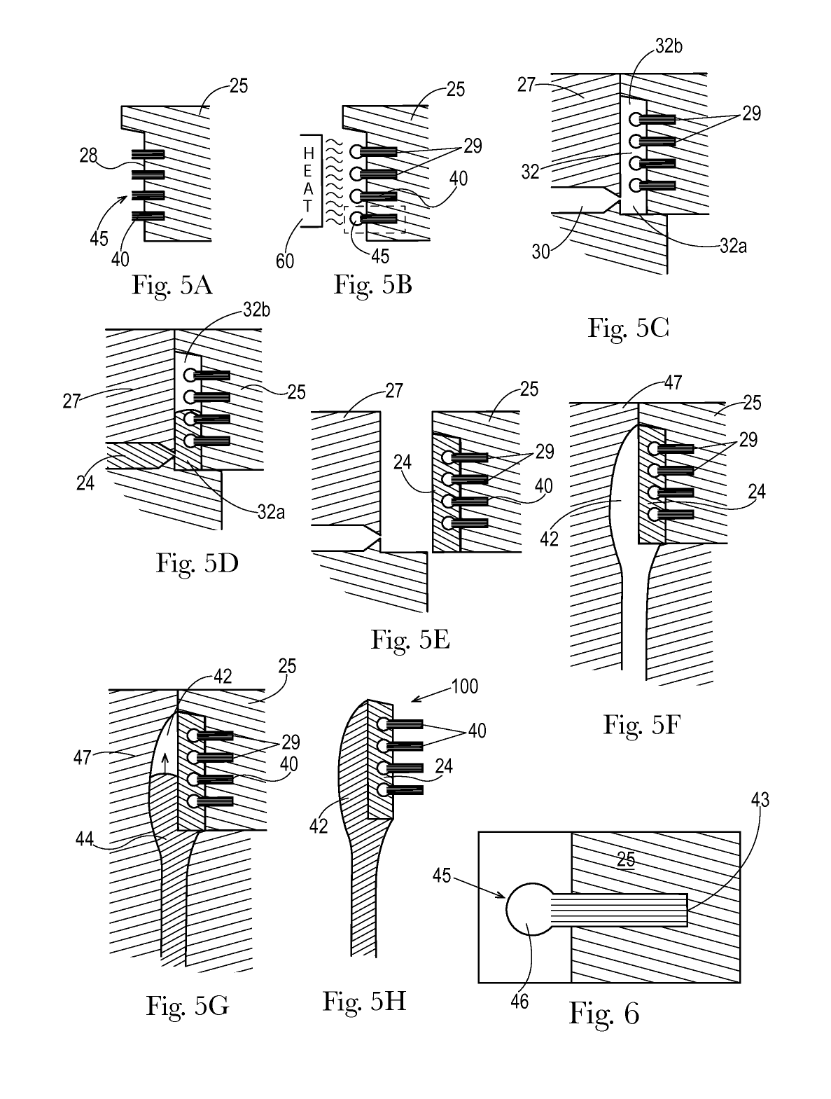

The free second ends 45 of the tufts 40 can then be interconnected by any means known in the art, to secure their retention in the article being formed. For example, the filaments' free ends 45 can be treated by heat, radiation, chemically, or otherwise—to melt the second ends 45, thereby interconnecting the second ends 45 by fusing together the individual bristles in each of the bristle tufts 40, as is illustrated in FIG. 5B. As a result of this melting, “thickenings,” or a “balls” 46, comprising interconnected second ends 45, can be formed, FIG. 6. These balls 46 will help to secure the tufts within the finished article. Some details pertaining to this aspect of the process can be found, for example, in U.S. Pat. Nos. 4,892,698 and 5,823,633, the disclosures of which are incorporated herein by reference for the purpose of explaining the formation of the balls, or thickenings, 46.

As is described herein above, the first mold cavity 32 can be formed by the first mold part 25 and the second mold part 27, securely clamped against one another to form the first mold cavity 32 therebetween. Any suitable press or clamping unit (not shown) can be used to apply a sufficient clamping force that is greater than the force exerted by the injection pressure inside the first mold cavity 32 and acting to separate the two mold parts 25, 27. The first mold cavity 32 has a volume, a front end 32a, and a rear end 32b opposite to the front end 32a (FIGS. 2 and 5C). Depending on the process's embodiment, the first mold cavity 32 may have a shape corresponding to either a shape of a finished tuft-holding portion of the tufted article being made—or a shape of a partially-made tuft-holding portion of the tufted article. The former takes place in an embodiment of the process comprising a single injection-molding operation, while the latter, illustrated in FIGS. 5A-5H, in an embodiment of the process comprising two or more injection-molding operations.

The steps of injecting a molten first thermoplastic material 24 into the first mold cavity 32 through a front end 32A thereof and controlling and adjusting melt pressure of the molten first thermoplastic material 24 according to a pressure-dominated algorithm are generally described herein above (FIGS. 1, 2, and 5D). A shot of molten first thermoplastic material 24 may be between 0.5 g and 100 g and may be advanced through a plurality of gates into the mold cavity. In some embodiments, a gate size can be between 0.5 mm and 3 mm.

During the first phase of the injection, when from about 90% to about 99% of a total volumetric capacity of the first mold cavity 32 is being filled with the molten first thermoplastic material 24, the melt pressure can be maintained at a constant low level from about 400 psi to about 4000 psi, more specifically from about 600 psi to about 3000 psi, and even more specifically from about 1000 psi to about 2000 psi. As is described herein above, maintaining low constant pressure can be accomplished by utilizing the first high-frequency sensor 52 in communication with the controller 50. Once it is detected (e.g., via a second transducer located near the known end-of-fill location of the mold cavity) that from about 90% to about 99% of a total volumetric capacity of the first mold cavity 32 has been filled with the molten first thermoplastic material 24, the melt pressure can be decreased so that the remaining volumetric capacity, from about 10% to about 1%, of the first mold cavity 32 can be filled with pressure from less than about 90% of the first pressure to about 20% of the initial pressure, and more specifically from about 90% to about 50% of the initial pressure. Alternatively, the melt pressure may be increased in some applications after about from 90% to 99% of a total volumetric capacity of the first mold cavity 32 has been filled with the molten first thermoplastic material 24. The injected first molten material 24 interconnects the balls 46 formed at the second ends 45 of the plurality of bristle tufts 40 with the first thermoplastic material 24, thereby securing the tufts 40 inside the article (or a part thereof) being made (FIGS. 5C-5H).

After the first mold cavity 32 is completely filled, the molten first thermoplastic material 24 can be cooled to cause its solidification inside the first mold cavity 32. Then, the first and second mold parts 25, 27 can be disengaged from one another (FIG. 5E). If the solidified first thermoplastic material 24, having the plurality of bristle tufts 40 embedded therein, comprises a finished tufted product, it can be released from the engagement with the first and second mold parts 25, 27 and removed therefrom by any means known in the art, for example, ejection, dumping, extraction (manually or via an automated process), pulling, pushing, gravity, or any other method of separating the cooled thermoplastic material from the first and second mold parts 25, 27. After the solidified thermoplastic material 24 is removed from the first and second mold parts 25, 27, the first and second mold parts 25, 27 can be closed, reforming the mold cavity in preparation for receiving a new shot of the molten first thermoplastic material 24, thereby completing a single injection-molding cycle.

If another injection-molding step is required to complete the construction of the finished tufted article, the process can be essentially repeated using another mold cavity. For example, a second mold cavity 42, can be formed between the first mold part 25 and a third mold part 47. The second injection-molding step may be controlled either by conventional means, i.e., a combination of a rate-dominated protocol and a pressure-dominated protocol—or by the means described herein, i.e., using solely a pressure-dominated algorithm. Other pressure-controlled means can be used, e.g., those disclosed in U.S. Pat. Nos. 6,506,902 and 5,441,680, and US Patent Application 2012/0294963, the disclosure of each being incorporated herein by reference.

A variety of thermoplastic materials can be used in the process of the disclosure. In one embodiment, the molten thermoplastic material has a viscosity, as defined by the melt-flow index (MFI), of about 0.1 g/10 min to about 500 g/10 min, as measured by ASTM D1238 performed at temperature of about 23° C. with a 2.16 kg weight. For polypropylene the MFI can be in a range of from about 0.5 g/10 min to about 200 g/10 min. Other suitable MFI ranges include from about 1 g/10 min to about 400 g/10 min, from about 10 g/10 min to about 300 g/10 min, from about 20 g/10 min to about 200 g/10 min, from about 30 g/10 min to about 100 g/10 min, from about 50 g/10 min to about 75 g/10 min, from about 0.1 g/10 min to about 1 g/10 min, and from about 1 g/10 min to about 25 g/10 min. The MFI of the material is selected based on the application and use of the molded article. For example, thermoplastic materials with an MFI of from about 0.1 g/10 min to about 5 g/10 min may be suitable for use as preforms for Injection Stretch Blow Molding (ISBM) applications. Thermoplastic materials with an MFI of from about 1.0 g/min to about 100 g/min may be suitable for molding all types of tufted articles. Thermoplastic materials made from a mixture of materials with MFIs between about 1.0 g/min and about 100 g/min may also be suitable for molding all tufted articles.

Manufacturers of such thermoplastic materials generally teach that the materials should be injection-molded using melt pressures in excess of 6000 psi, and often in excess of 6000 psi. Contrary to conventional teachings regarding injection molding of such thermoplastic materials, embodiments of the low-constant-pressure injection-molding process and device of the disclosure advantageously allow for forming quality injection-molded tufted articles or their parts using such thermoplastic materials and processing at melt pressures well below 6000 psi.

The thermoplastic material can be, for example, a polyolefin. Exemplary polyolefins include, but are not limited to, polypropylene, polyethylene, polymethylpentene, and polybutene-1. Any of the aforementioned polyolefins could be sourced from bio-based feedstocks, such as sugarcane or other agricultural products, to produce a bio-polypropylene or bio-polyethylene. Polyolefins advantageously demonstrate shear thinning when in a molten state. Shear thinning is a reduction in viscosity when the fluid is placed under compressive stress. Shear thinning can beneficially allow for the flow of the thermoplastic material to be maintained throughout the injection-molding process. Without intending to be bound by theory, we believe that the shear thinning properties of a thermoplastic material, and in particular polyolefins, results in less variation of the materials viscosity when the material is processed at constant pressures. As a result, embodiments of the method and device of the disclosure can be less sensitive to variations in the thermoplastic material, for example, resulting from colorants and other additives as well as processing conditions. This decreased sensitivity to batch-to-batch variations of the properties thermoplastic material can also advantageously allow post-industrial and post consumer recycled plastics to be processed using embodiments of the method and the device of the disclosure. Post-industrial, post consumer recycled plastics are derived from end products that have completed their life cycle as a consumer item and would otherwise have been disposed of as a solid waste product. Such recycled plastic, and blends of thermoplastic materials, inherently have significant batch-to-batch variation of their material properties.

The thermoplastic material can also be a polyester. Exemplary polyesters include, but are not limited to, polyethylene terphthalate (PET). The PET polymer could be sourced from bio-based feedstocks, such as sugarcane or other agricultural products, to produce a partially or fully bio-PET polymer. Other suitable thermoplastic materials include copolymers of polypropylene and polyethylene, and polymers and copolymers of thermoplastic elastomers, polyester, polystyrene, polycarbonate, poly(acrylonitrile-butadiene-styrene), poly(lactic acid), bio-based polyesters such as poly(ethylene furanate) polyhydroxyalkanoate, poly(ethylene furanoate), (considered to be an alternative to, or drop-in replacement for, PET), polyhydroxyalkanoate, polyamides, polyacetals, ethylene-alpha olefin rubbers, and styrene-butadiene-styrene block copolymers. The thermoplastic material can also be a blend of multiple polymeric and non-polymeric materials. The thermoplastic material can be, for example, a blend of high, medium, and low molecular polymers yielding a multi-modal or bi-modal blend. The multi-modal material can be designed in a way that results in a thermoplastic material that has superior flow properties yet has satisfactory chemo/physical properties.

The thermoplastic material can also be a blend of a polymer with one or more small molecule additives. The small molecule could be, for example, a siloxane or other lubricating molecule that, when added to the thermoplastic material, improves the flowability of the polymeric material. Other additives may include inorganic fillers such calcium carbonate, calcium sulfate, talcs, clays (e.g., nanoclays), aluminum hydroxide, CaSiO3, glass formed into fibers or microspheres, crystalline silicas (e.g., quartz, novacite, crystallobite), magnesium hydroxide, mica, sodium sulfate, lithopone, magnesium carbonate, iron oxide; or, organic fillers such as rice husks, straw, hemp fiber, wood flour, or wood, bamboo or sugarcane fiber.

Other suitable thermoplastic materials include renewable polymers such as nonlimiting examples of polymers produced directly from organisms, such as polyhydroxyalkanoates (e.g., poly(beta-hydroxyalkanoate), poly(3-hydroxybutyrate-co-3-hydroxyvalerate, NODAX (Registered Trademark)), and bacterial cellulose; polymers extracted from plants, agricultural and forest, and biomass, such as polysaccharides and derivatives thereof (e.g., gums, cellulose, cellulose esters, chitin, chitosan, starch, chemically modified starch, particles of cellulose acetate), proteins (e.g., zein, whey, gluten, collagen), lipids, lignins, and natural rubber; thermoplastic starch produced from starch or chemically starch and current polymers derived from naturally sourced monomers and derivatives, such as bio-polyethylene, bio-polypropylene, polytrimethylene terephthalate, polylactic acid, NYLON 11, alkyd resins, succinic acid-based polyesters, and bio-polyethylene terephthalate.

The suitable thermoplastic materials may include a blend or blends of different thermoplastic materials such in the examples cited above. As well the different materials may be a combination of materials derived from virgin bio-derived or petroleum-derived materials, or recycled materials of bio-derived or petroleum-derived materials. One or more of the thermoplastic materials in a blend may be biodegradable. And for non-blend thermoplastic materials that material may be biodegradable.

The disclosed low-constant-pressure injection-molding process and apparatus, which utilize a pressure-dominated algorithm to control the melt pressure, can achieve one or more advantages over conventional high-variable-pressure injection-molding processes using a rate-dominated algorithm. The former are believed to be more cost-effective and efficient; it eliminates the need to balance the pre-injection pressures of the mold cavity and the thermoplastic materials and allows one to use atmospheric mold-cavity pressures. This, in turn, allows manufacturers to use simplified mold structures that eliminate the necessity of pressurizing means, mold-cavity materials that have lower hardness and high thermal conductivity; these materials are more cost effective and easier to machine. This further allows manufacturers to use a more robust processing method that is less sensitive to variations in the temperature, viscosity, and other material properties of the thermoplastic material, and the ability to produce quality injection-molded tufted products or parts thereof at substantially constant low pressures without premature hardening of the thermoplastic material in the mold cavity and without the need to heat or maintain constant temperatures in the mold cavity.

At least one of the first mold part 27 and the second mold part 27 may have an average thermal conductivity of more than 51.9 W/m-° C. (30 BTU/HR FT ° F.) and less than or equal to 385.79 W/m-° C. (223 BTU/HR FT ° F.). In some embodiments, both the first and second mold side may have an average thermal conductivity of more than 51.9 W/m-° C. (30 BTU/HR FT ° F.) and less than or equal to 385.79 W/m-° C. (223 BTU/HR FT ° F.). Examples of materials that can be used for manufacturing the first and/or second mold parts 25, 27 include: aluminum (e.g., 2024 aluminum, 2090 aluminum, 2124 aluminum, 2195 aluminum, 2219 aluminum, 2324 aluminum, 2618 aluminum, 5052 aluminum, 5059 aluminum, aircraft-grade aluminum, 6000-series aluminum, 6013 aluminum, 6056 aluminum, 6061 aluminum, 6063 aluminum, 7000-series aluminum, 7050 aluminum, 7055 aluminum, 7068 aluminum, 7075 aluminum, 7076 aluminum, 7150 aluminum, 7475 aluminum, QC-10, Alumold™, Hokotol™, Duramold 2™, Duramold 5™, and Alumec 99™); BeCu (e.g., C17200, C18000, C61900, C62500, C64700, C82500, Moldmax LH™, Moldmax HH™, and Protherm™); Copper; any alloys of aluminum (e.g., Beryllium, Bismuth, Chromium, Copper, Gallium, Iron, Lead, Magnesium, Manganese, Silicon, Titanium, Vanadium, Zinc, Zirconium); any alloys of copper (e.g., Magnesium, Zinc, Nickel, Silicon, Chromium, Aluminum, Bronze). These materials may have Rockwell C (Rc) hardness of between 0.5 Rc and 20 Rc, specifically between 2 Rc and 20 Rc, more specifically between 3 Rc and 15 Rc, and even more specifically between 4 Rc and 10 Rc. While these materials may be softer than tool steels, the thermal conductivity properties are more desirable. The disclosed process and apparatus advantageously operate under molding conditions that allow molds made of these softer, higher thermal conductivity, materials to extract useful lives of more than 1 million cycles, or between 1.25 million cycles and 10 million cycles, or between 2 million cycles and 5 million cycles.

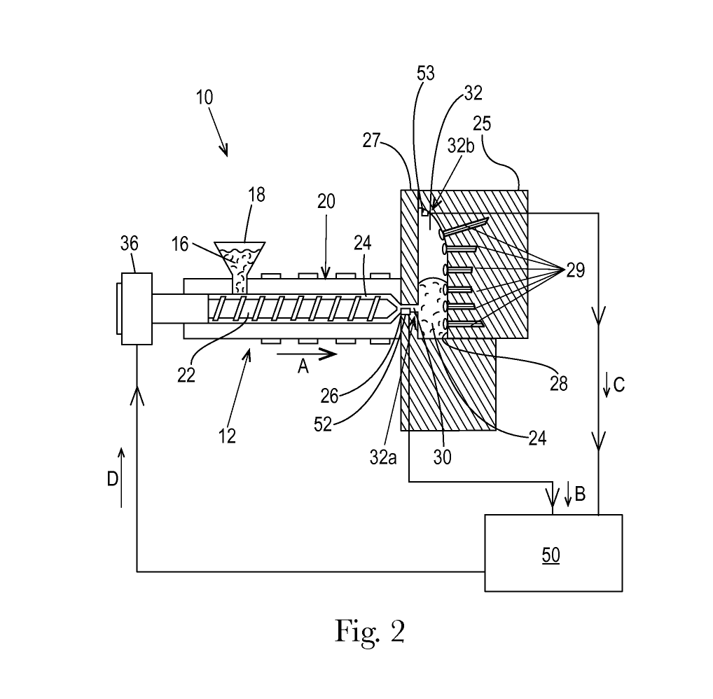

In FIG. 3, the dashed line 200 represents a typical pressure—time curve for a conventional high-variable-pressure injection-molding process, and the solid line 20 represents a pressure-time curve for the disclosed low-constant-pressure injection-molding machine. In the conventional process, melt pressure is rapidly increased to well over 15,000 psi and then held relatively high, more than 15,000 psi, for a first period of time 220. In the conventional process, the first period of time 220 is the fill time in which molten plastic material flows into the mold cavity. Thereafter, the melt pressure is decreased and held at a lower, but still relatively high level, typically 10,000 psi or more, for a second period of time 230—a so-called “packing” time, during which the melt pressure is maintained to ensure that all gaps in the mold cavity are filled. After packing is complete, the pressure may optionally be dropped again for a third period of time 232, which is the cooling time. The mold cavity in a conventional system is packed from the end of the flow channel back towards the gate. The material in the mold typically freezes off near the end of the cavity; then completely frozen region of material progressively moves toward the gate location, or locations. As a result, the material near the end of the mold cavity is packed for a shorter time and with reduced pressure compared to the material that is closer to the gate location (or locations if there are more than one gate). The particular geometry of the part being constructed, such, for example, as very thin cross-sectional areas intermediate the gate and the mold cavity's end, can also influence the level of packing pressure in regions of the mold cavity. Inconsistent packing pressure will likely cause inconsistencies in the finished product, as discussed above. Moreover, the conventional packing of plastic in various stages of solidification results in some non-ideal material properties, for example, molded-in stresses, sink, and non-optimal optical properties.

The low-constant-pressure injection-molding system, on the other hand, will allow manufacturers to inject the molten plastic material into the mold cavity at a substantially constant injection pressure for a fill time 240, FIG. 3. After the mold cavity is filled, the low-constant-pressure system gradually reduces pressure over a second time period 242 as the molded part is cooled. Under a substantially constant pressure, the molten thermoplastic material maintains a continuous melt-flow front that advances through the flow channel from the gate towards the end of the flow channel. In other words, the molten thermoplastic material remains moving throughout the mold cavity, which prevents premature freeze off. Thus, the plastic material remains relatively uniform at any point along the flow channel, which results in a more uniform and consistent finished product. The process of filling the mold under a relatively uniform pressure causes the finished molded parts to form crystalline structures that have better mechanical and optical properties than those of conventionally molded parts. Moreover, the parts molded at constant pressures exhibit superior characteristics to the “skin” layers of conventionally molded parts—and thus have better optical properties than conventionally molded parts.

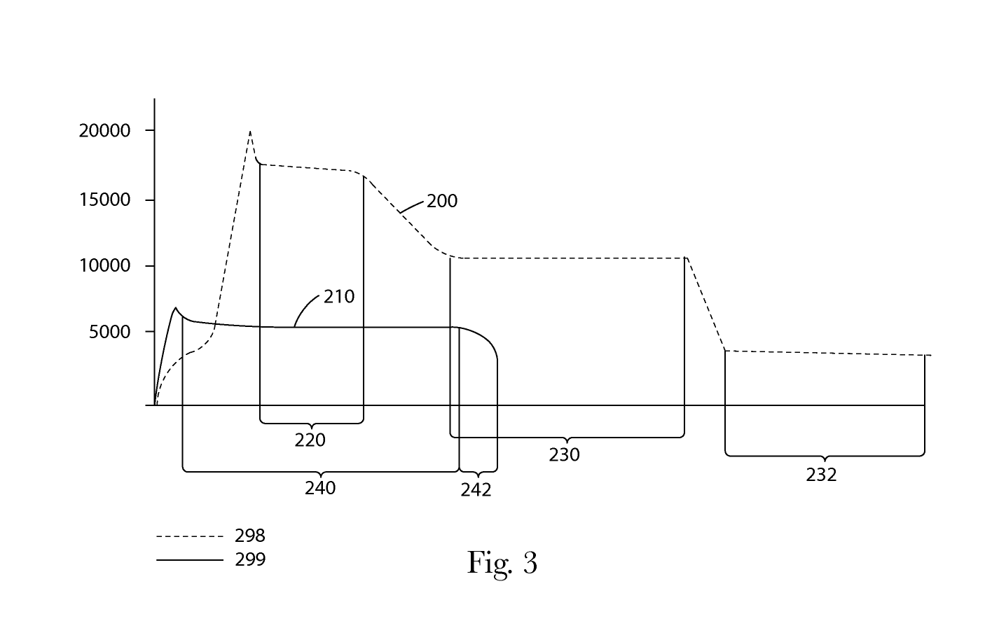

In FIG. 4, the various stages of fill are broken down as percentages of overall fill time. For example, in an conventional high-variable-pressure process, the rate-dominated fill period 220 makes up about 10% of the total fill time, the packing period 230 makes up about 50% of the total fill time, and the cooling period 232 makes up about 40% of the total fill time. On the other hand, in the low-constant-pressure injection-molding process, the pressure-dominated fill period 240 makes up about 90% of the total fill time, while the cooling period 242 makes up only about 10% of the total fill time. The low-constant-pressure process needs less cooling time because the molten plastic material is cooling as it is flowing into the mold cavity. Thus, by the time the mold cavity is filled, the plastic material has cooled significantly, although not quite enough to freeze off in the center cross-section of the mold cavity; and there is less total heat to remove to complete the freezing process. Additionally, because the plastic material remains liquid throughout the fill, and packing pressure is transferred through this molten center cross-section, the plastic material remains in contact with the mold-cavity walls (as opposed to freezing off and shrinking away). As a result, one using the low-constant-pressure process can fill and cool a molded part in less total time than in a conventional high-variable-pressure process.

The disclosed process and apparatus advantageously reduce cycle time for the injection-molding process while increasing the quality of the parts produced thereby. Moreover, the disclosed process and apparatus may employ, in some embodiments, electric presses, which are generally more energy-efficient and require less maintenance than hydraulic presses. Additionally, the disclosed apparatus is capable of employing more flexible support structures and more adaptable delivery structures, such as wider platen widths, increased tie bar spacing, elimination of tie bars, lighter weight construction to facilitate faster movements, and non-naturally balanced feed systems. Thus, the machinery can be easily modified to fit production needs and customized for particular molded parts.

What's more, the disclosed process and apparatus allow the molds to be made from softer materials (e.g., materials having a Rc of less than about 30), which may have higher thermal conductivities (e.g., thermal conductivities greater than about 20 BTU/HR FT ° F.). This would make it possible and advantageous to use molds with improved cooling capabilities and more uniform cooling. Also, the improved cooling capabilities of the disclosed apparatus would encourage the use of simplified cooling systems, which may include fewer cooling channels; and the cooling channels may become straighter, having fewer machining axes. One example of an injection mold having a simplified cooling system is disclosed in U.S. Patent Application No. 61/602,781, the disclosure of which is incorporated by reference herein.

In addition, the lower injection pressures of the apparatus of the invention allow molds made of these softer materials to perform 1 million or more molding cycles. This would not be possible on conventional high-variable-pressure injection-molding machines as these materials, experiencing very high pressures used in the conventional machines, would likely fail before reaching 1 million molding cycles.

The disclosure of every document cited herein, including any cross-referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein—or that it alone, or in any combination with any other reference or references, teaches, suggests, or discloses any such invention. Further, to the extent that any meaning or definition of a term in this document conflicts with any meaning or definition of the same or similar term in a document incorporated by reference, the meaning or definition assigned to that term in this document shall govern.

The steps of the disclosed processes can be performed in an order different from the sequence in which the steps appear in the text herein. While particular embodiments have been illustrated and described herein, various other changes and modifications may be made without departing from the spirit and scope of the invention. Moreover, although various aspects of the invention have been described herein, such aspects need not be utilized in combination. It is therefore intended to cover in the appended claims all such changes and modifications that are within the scope of the invention.

What is claimed is:

1. A process for making a tufted article comprising a plastic body and a plurality of bristle tufts, the process comprising:
causing at least a first mold part and a second mold part to form a first mold cavity therebetween, the first mold part having a working surface and a plurality of holes formed therein to receive a plurality of bristle tufts, each bristle tuft comprising a plurality of individual bristles, the first mold cavity having a volume, a front end, and a rear end opposite to the front end;
inserting the plurality of bristle tufts into the plurality of holes in the first mold part, each of the bristle tufts having a first end, a second end opposite to the first end, and a longitudinal axis running though the first and second ends, the first ends of the bristle tufts being disposed inside the first mold part while the second ends of the bristle tufts extend into the first mold cavity;
injecting a molten first thermoplastic material into the first mold cavity through the front end thereof, thereby interconnecting the second ends of the plurality of bristle tufts with the first thermoplastic material, the molten first thermoplastic material having a melt-flow index of from about 0.1 g/10 min to about 500 g/10 min and a melt pressure in the first mold cavity of from about 10 psi to about 2000 psi;
controlling and adjusting melt pressure of the molten first thermoplastic material according to a pressure-dominated algorithm comprising detecting at least 100 melt-pressure measurements per second upstream the front end of the first mold cavity;
cooling the molten first thermoplastic material thereby causing the first thermoplastic material to solidify inside the first mold cavity; and
disengaging the first mold part and the second mold part thereby releasing the solidified first thermoplastic material having the plurality of bristle tufts embedded therein.

2. The process of claim 1, wherein controlling and adjusting melt pressure of the molten first thermoplastic material according to a pressure-dominated algorithm comprises high-frequency monitoring of at least a first melt pressure of the molten first thermoplastic material measured at at least a first injection nozzle disposed upstream and adjacent to the front end of the first mold cavity.

3. The process of claim 2, wherein controlling and adjusting melt pressure of the molten first thermoplastic material according to a pressure-dominated algorithm comprises high-frequency monitoring of at least a second melt pressure of the first molten thermoplastic material at the rear end of the first mold cavity.

4. The process of claim 3, wherein the step of controlling and adjusting the melt pressure of the molten first thermoplastic material according to a pressure-dominated algorithm comprises processing and analyzing results of the high-frequency monitoring of at least the first melt pressure and the second melt pressure and, based on the results of said monitoring, generating a signal to adjust injection pressure of the first thermoplastic material.

5. The process of claim 4, wherein processing and analyzing the results of the high-frequency monitoring of the first melt pressure and the second melt pressure includes averaging of the melt-pressure measurements.

6. The process of claim 1, wherein the step of controlling and adjusting the melt pressure of the molten first thermoplastic material according to a pressure-dominated algorithm comprises maintaining the melt pressure in the injection nozzle from 400 psi to 4000 psi until from about 90% to about 99% of a total volumetric capacity of the first mold cavity is filled with the molten first thermoplastic material.

7. The process of claim 6, wherein the step of controlling and adjusting the melt pressure of the molten first thermoplastic material according to a pressure-dominated algorithm further comprises decreasing the melt pressure inside the first mold cavity while continuing filling from about remaining 10% to about remaining 1% of the total volumetric capacity of the first mold cavity with the first molten thermoplastic material.

8. The process of claim 1, further comprising:
causing the first mold part and a third mold part to form a second mold cavity therebetween, the second mold cavity having a second volume, a first end, and a second end opposite to the first end;
injecting a molten second thermoplastic material having a melt-flow index of from about 1 to about 100 and a melt pressure of from about 100 psi to about 12,000 psi into the second mold cavity such that the molten second thermoplastic material at least partially covers the first thermoplastic material;
controlling and adjusting melt pressure of the second molten thermoplastic material according to a pressure-dominated algorithm;
cooling the second thermoplastic material thereby causing the second thermoplastic material to solidify and attach to the first thermoplastic material; and
disengaging the first mold part and the third mold part.

9. The process of claim 8, wherein the step of controlling and adjusting the melt pressure of the molten second thermoplastic material according to a pressure-dominated algorithm comprises detecting at least 100 melt-pressure measurements per second of the molten second thermoplastic material upstream the first end of the second mold cavity.

10. The process of claim 9, wherein detecting at least 100 melt-pressure measurements per second of the molten second thermoplastic material comprises high-frequency monitoring of at least a third melt pressure of the molten second thermoplastic material measured at at least a second injection nozzle disposed adjacent to the first end of the second mold cavity.

11. The process of claim 10, wherein detecting at least 100 melt-pressure measurements per second from inside the second mold cavity further comprises high-frequency monitoring of at least a fourth melt pressure of the molten second thermoplastic material at the second end of the second mold cavity.

12. The process of claim 11, wherein the step of controlling and adjusting the melt pressure of the molten second thermoplastic material according to a pressure-dominated algorithm comprises processing and analyzing results of the high-frequency monitoring of at least the third melt pressure and the fourth melt pressure and, based on the results of said monitoring, generating a signal to adjust injection pressure of the second thermoplastic material.

13. The process of claim 12, wherein processing and analyzing the results of the high-frequency monitoring of at least the third melt pressure and the fourth melt pressure includes averaging of the melt-pressure measurements.

14. The process of claim 8, wherein the step of controlling and adjusting the melt pressure of the molten second thermoplastic material according to a pressure-dominated algorithm comprises maintaining the melt pressure inside the second mold cavity from 100 psi to 12,000 psi until from about 90% to about 99% of a total volumetric capacity of the second mold cavity is filled with the molten second thermoplastic material.

15. The process of claim 14, wherein the step of controlling and adjusting the melt pressure of the molten second thermoplastic material according to a pressure-dominated algorithm further comprises decreasing the melt pressure inside the second mold cavity while continuing filling from about remaining 10% to about remaining 1% of the total volumetric capacity of the second mold cavity with the second molten thermoplastic material.

16. The process of claim 8, wherein the first thermoplastic material and the second thermoplastic material differ from one another in at least one characteristic or parameter selected from the group consisting of hardness, stiffness, durability, color, chemical composition, texture, surface roughness, porosity, surface finish, transparency, translucency, and density.

17. An apparatus for making a tufted body by injection-molding, the apparatus comprising:
at least a first mold part and a second mold part, the first and second mold parts forming therebetween a first mold cavity for receiving a molten first thermoplastic material therein, the first mold cavity having a volume, a front end, and a rear end opposite to the front end, the first mold part having a working surface and a plurality of holes formed therein for receiving a plurality of bristle tufts, each bristle tuft comprising a plurality of individual bristles;
an injection device comprising at least a first injection nozzle for injecting a molten first thermoplastic material into the first mold cavity; and
a pressure-control mechanism for monitoring a melt pressure of the molten first thermoplastic material and adjusting an injection pressure imparted by the injection device on the molten first thermoplastic material according to a pressure-dominated algorithm based on the melt pressure of the molten first thermoplastic material, wherein the pressure-control mechanism comprises at least a first high-frequency pressure sensor located upstream the front end of the first mold cavity.

18. The apparatus of claim 17, further comprising a third mold part, the first mold part and the third mold parts forming therebetween a second mold cavity for receiving a second molten thermoplastic material therein, the second mold cavity having a second volume, a first end, and a second end opposite to the first end.

19. The apparatus of claim 18, wherein the pressure control mechanism further comprises:
at least a second high-frequency pressure sensor located at the rear end of at least one of the first mold cavity and the second mold cavity;
a controller in operative communication with the at least first high-frequency pressure sensor and the second high-frequency pressure sensor for computing a required injection pressure; and
an injection-control unit in operative communication with the controller for providing the required pressure while injecting at least one of the molten first thermoplastic material and the second thermoplastic material into at least one of the first mold cavity and the second mold cavity.

20. The apparatus of claim 19, wherein each of the at least a first high-frequency pressure sensor and a second high-frequency pressure sensor comprises a piezoelectric transducer structured to detect at least 100 melt-pressure measurements per second.

21. The apparatus of claim 19, wherein the controller comprises a central processing unit having at least one input and at least one output and configured to control the injection pressure and to transfer control of the injection pressure to or from another injection-molding control system.

22. The apparatus of claim 19, wherein each of the at least a first high-frequency pressure sensor and a second high-frequency pressure sensor comprises a piezoelectric transducer structured to detect at least 500 melt-pressure measurements per second.

23. The process of claim 1, wherein controlling and adjusting melt pressure of the molten first thermoplastic material according to a pressure-dominated algorithm comprises detecting at least 500 melt-pressure measurements per second upstream the front end of the first mold cavity.

24. The process of claim 1, further comprising interconnecting the second ends of the bristle tufts.

25. The process of claim 24, wherein interconnecting the second ends of the bristle tufts comprises melting the second ends of the bristle tufts to fuse together the plurality of individual bristles in each of the bristle tufts.
